(19) United States
(12) Patent Application Publication
(10) Pub. No.: US 2002/0150060 A1
(43) Pub. Date: Oct. 17, 2002

(54) ASYMMETRIC FORMATTING SYSTEM AND METHOD FOR LOW-EARTH-ORBIT SATELLITE DATA COMMUNICATION

(76) Inventor: MARIE-JOSE MONTPETIT, BELLEVUE, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 09/145,392

(22) Filed: Sep. 1, 1998

(51) Int. Cl. H04B 7/185

(52) U.S. Cl. 370/316

(57) ABSTRACT

A data communication system for a constellation of low-Earth-orbit (LEO) satellites (14a, 14b, . . . ) is disclosed. The data to be communicated is received by a transmitting ground terminal (50) either from one of a number of other networks (19a, 19b, . . . ) or an end user (17d, 17e, or 17f) in the form of data packets of varying lengths and protocols. Each data packet includes a header (41) and a payload (43). The header (41) contains address and other control information and the payload (43) contains the data to be communicated. The data packets are formatted by a formatting system (51) in the ground terminal (50) into standard data packets of uniform length having a standard header (65) and a standard payload (67). Upon receipt by an uplink satellite (54), the standard header (65) of the standard data packets is appended with data for system management to create asymmetric standard data packets having an asymmetric header (66) and standard payload (67). The appended databits are used for system management purposes, for example, to identify lost data packets and to advise ground terminal control programs if the route taken by a data packet through the satellite constellation is congested. The downlink satellite (56) removes the formerly appended data to create reproduced standard data packets. Upon receipt by a receiving ground terminal (60), reproduced standard data packets are deformatted by the deformatting system (61) located in the receiving ground terminal (60) to create the original data packets of varying lengths and protocols.

### FIELD OF THE INVENTION

This invention relates to data communication systems and, more particularly, to digital satellite data communication systems.

### BACKGROUND OF THE INVENTION

In recent years the need for global data networking capability has rapidly expanded. In order to meet this need, broadband satellite communication systems have been proposed as an alternative to land-based communication systems. One type of satellite data communication system is described in a variety of U.S. patents assigned to the assignee of this patent application, including U.S. Pat. Nos. 5,386,953; 5,408,237; 5,527,001; 5,548,294; 5,641,135; 5,642,122, and 5,650,788. These patents and other pending applications assigned to the assignee of this patent application describe a satellite communication system that includes a constellation of low-Earth-orbit (LEO) satellites that implement an Earth-fixed cellular beam approach to transmitting data from one location on the Earth's surface to another location. More specifically, each LEO satellite has a communication “footprint” that covers a portion of the Earth's surface as a satellite passes over the Earth. The communication footprint defines the area of the Earth within which ground terminals can communicate with the satellite. Located within each footprint are a large number of cells. During the period of time a cell remains within the borders of a satellite footprint, ground terminals located in the cell transmit data to and receive data from the “servicing” satellite. When a satellite reaches the end of its servicing arc, another satellite in orbit is positioned to “service” the Earth-fixed cells previously covered by the satellite reaching the end of its servicing arc. During servicing, the antennas of ground terminals located in the cells continuously point toward the servicing satellite as it moves in orbit and antennas on the satellite point toward the cells during the time period within which the ground terminals in the cells are allowed to transmit data. Other LEO satellite communication systems employ a satellite-fixed beam approach to transmitting data from one location on the Earth's surface to another location.

Regardless of the nature of the LEO satellite communication system, Earth-fixed cell or satellite-fixed beam, data to be sent from one location on the Earth to another location is transmitted from a ground terminal located within a cell to the satellite serving the cell via an uplink data channel. The data is routed through the constellation of LEO satellites via an intersatellite link data channel to the satellite serving the cell within which the ground terminal of the designated receiver is located. The latter satellite transmits the data to the receiving ground terminal via a downlink data channel. Thus, the constellation of LEO satellites and the ground terminals form a satellite data communication network wherein each ground terminal and satellite forms a node of the network.

Typically, data transmissions sent via uplink, intersatellite link or downlink data channels are broken into digital data “packets,” each of which include a header and a payload. The header contains address and control information designed to direct the data packets through the satellite constellation to a receiving ground terminal or to a satellite. The payload contains the information being transmitted, which is intended for the satellite or the ground terminal or both.

In order for a LEO satellite data communication system to be competitive, it must support broadband transmission, be of relatively low cost, and maintain end user quality of service. Low cost requires that the satellites be light in weight and relatively inexpensive to manufacture. One way of keeping satellite weight and cost low is to minimize the complexity of the network design. Unfortunately, minimizing the network complexity often conflicts with the need to maintain a high end user quality of service.

The present invention is directed to a LEO satellite data communication system that formats data packets in a sending ground terminal and asymmetrically reformats the header of the data packets in a receiving satellite to minimize the complexity of the satellites, maximize the overall capacity of the network, and maximize the end user quality of service.

### SUMMARY OF THE INVENTION

In accordance with this invention, a low-Earth-orbit (LEO) satellite data communication system is provided. Data to be transmitted from one location on the Earth to another location is assembled into digital data packets each of which includes a header and a payload. The header includes address and other control information, and the payload contains the information to be transmitted. A sending ground terminal initially receives data packets of varying lengths and protocols from a number of other networks or end users. The received data packets are formatted by a formatting system located in the sending ground terminal to create standard data packets of uniform length. The standard data packets are transmitted to a receiving satellite via an uplink data communication channel. The receiving satellite appends system management data to the header of the standard data packets to create asymmetric standard data packets. The satellite on-board processing system then uses the header information to route the data packets through the satellite constellation to an appropriate sending satellite. The sending satellite removes the appended data from the header of the asymmetric standard data packets to create reproduced standard data packets. The reproduced standard data packets are then transmitted to a receiving ground terminal via a downlink data communication channel. The receiving ground terminal deformats the reproduced standard data packet creating the original data packets of varying lengths and protocols. These data packets are then transmitted to the destined other networks or end users.

In accordance with other aspects of this invention, the appended system management data includes a timer count. The timer count is used by a processing system to track the length of time the asymmetric standard data packet is routed through the satellite system. After a predetermined period of time has elapsed, the asymmetric data packet is presumed to be misrouted or unacceptably delayed and, as a result, is no longer routed through the satellite system (i.e., dropped).

In accordance with further aspects of this invention, the appended system management data includes a congestion indicator. The congestion indicator is used by the processing system to record the congestion status of the routing path of the asymmetric standard data packet. If the timer count has not caused the asymmetric data packets to be dropped from the system, both the timer count and congestion indicator are removed from the header before the sending satellite transmits the data packets to the receiving ground station. However, before the congestion indicator is removed, it is copied into a surviving part of the header in order to store the information for use by the receiving ground terminal.

As will be readily appreciated from the foregoing description, the invention provides a data communication system that employs a formatting and processing system for creating standard data packets of uniform length and common protocol and later appending data to the headers of these standard data packets, producing asymmetric standard data packets, that are ideally suited for use in a low-Earth-orbit (LEO) satellite system. Because packets from a variety of network protocols are reformatted into fixed length data packets in the ground terminals, the complexity of the satellites is substantially lowered. Further, by using fixed length data packets in the uplink and downlink data channels, which occur over a fixed bandwidth, while using asymmetric data packets in the intersatellite link data channels, where the bandwidth is greater than will likely be used at any given time, the overall capacity of the network is maximized. Also, appending a timer count and congestion indicator improves the flow and routing control of packets through the system, which ultimately maximizes the end user quality of service.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a pictorial diagram showing the orbital paths of the satellites of a constellation of low-Earth-orbit (LEO) satellites positioned to cover the entire surface of the Earth;

FIG. 2 is a plan view of a portion of the constellation of LEO satellites depicted in FIG. 1;

FIG. 3 is a pictorial view showing the various signal paths to and from a constellation of LEO satellites of the type depicted in FIGS. 1 and 2;

FIG. 4 illustrates a data packet of the type employed by a LEO satellite data communication system;

FIG. 5 is a functional block diagram that illustrates the uplink and downlink components of a LEO satellite data communication system;

FIG. 6 illustrates a data packet of the type employed by the invention in the uplink data communication channels of a LEO satellite data communication system;

FIG. 7 illustrates a data packet of the type employed by the invention in the intersatellite data communication channels of a LEO satellite data communication system;

FIG. 8 illustrates a data packet of the type employed by the invention in the downlink data communication channels of a LEO satellite data communication system;

FIG. 9 is a functional block diagram that illustrates a generic satellite on-board processing system suitable for use in the LEO satellite data communication system depicted in FIG. 5;

FIG. 10A is a functional flow diagram that illustrates the operation of the portion of the satellite on-board processing system depicted in FIG. 9 directed to the addition of timer count bits and a congestion bit;

FIG. 10B is a functional flow diagram that illustrates the operation of the portion of the satellite on-board processing system depicted in FIG. 9 directed to the updating of timer count bits and a congestion bit;

FIG. 10C is a functional flow diagram that illustrates the operation of the portion of the satellite on-board processing system depicted in FIG. 9 directed to the removal of timer count bits and a congestion bit; and

FIG. 11 is a functional flow diagram that illustrates an alternative method of updating the timer count bits and congestion bit.

### DETAILED DESCRIPTION OF THE PREFERRED EMBODIMENT

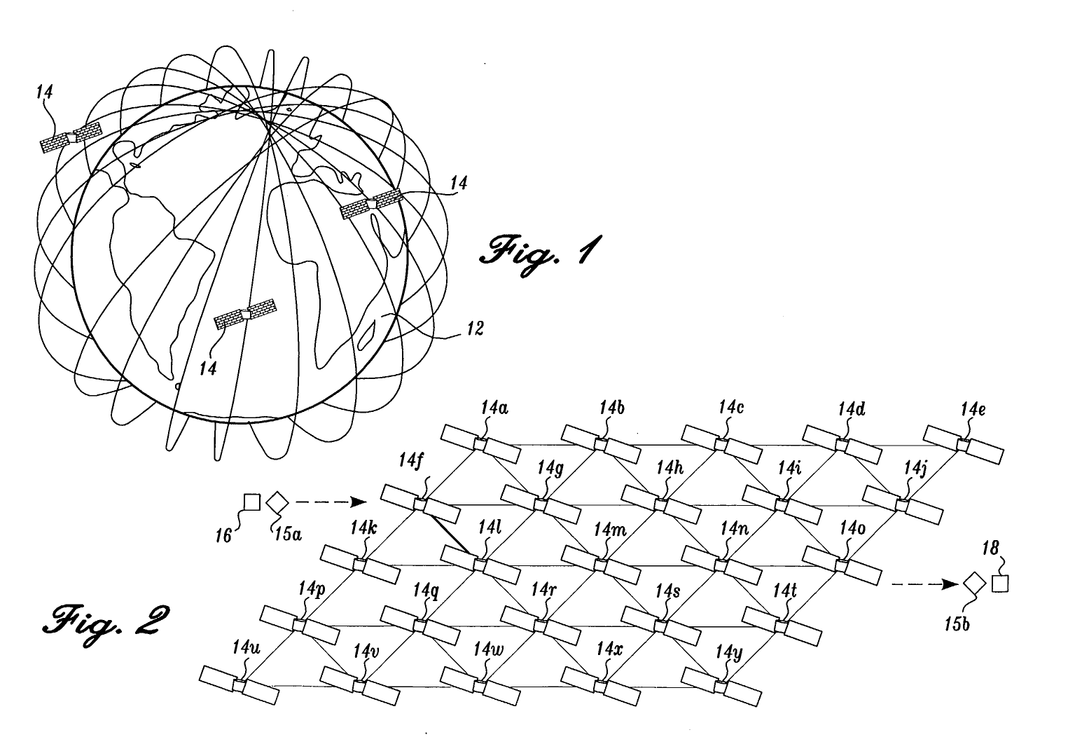

The present invention is directed to a data communication system that is ideally suited for use in a low-Earth-orbit (LEO) satellite communication network. A LEO satellite communication network includes a constellation of satellites orbiting the Earth such that a majority of the Earth is within the view of at least one satellite at any point in time. One proposed LEO satellite communication network employs 288 satellites, plus spares, located in 12 polar orbit planes. Each plane includes 24 satellites at an altitude of approximately 1,350 kilometers. The path of travel of the satellites of such a network is generally depicted in FIG. 1. More specifically, FIG. 1 depicts the Earth 12 surrounded by a plurality of rings that depict the orbital planes of a plurality of satellites 13.

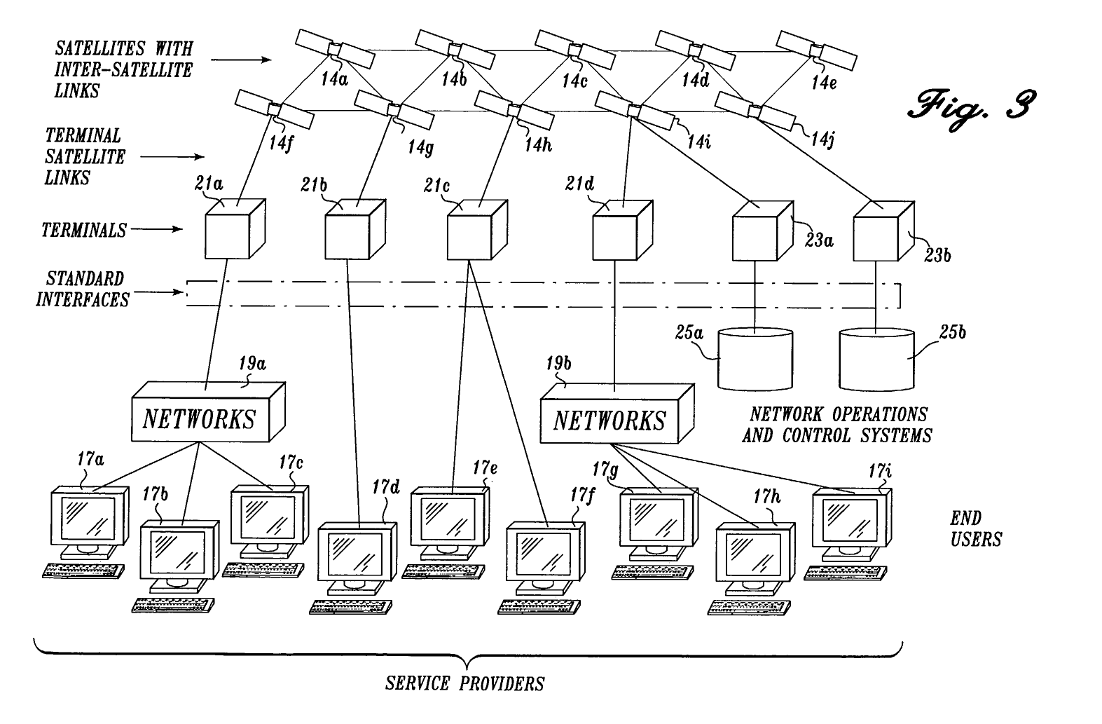

FIG. 2 illustrates a number of the satellites 14a, 14b, 14c . . . that make up the constellation of satellites included in a LEO satellite communication network of the type illustrated in FIG. 1. The satellites are shown closer to one another for illustrative purposes only. As shown in FIG. 2, a data signal 15a, consisting of one or more data packets, is transmitted on an uplink data communication channel by a ground terminal 16 and received by a first satellite 14f that forms part of the constellation of satellites. The data packets are routed through the constellation of satellites. The routing path is dependent on network traffic. For example, the receiving or uplink satellite may forward the one or more data packets to a second satellite 141, which forwards the data packets to a third satellite 14m, which forwards the data packets to a fourth satellite 14n. The routing continues until the data packets reach the satellite 14o associated with the ground terminal 18 that is to receive the data packets. This satellite, called the sending or downlink satellite, transmits the data packets as a data signal 15b to the receiving ground terminal 18. The receiving ground terminal forwards the data to an end user. It is to be understood that the data packets of a message may be routed through different paths in the constellation of satellites and may arrive at the ground terminal in a different order than they were sent. In this case, upon receipt at the ground terminal, the data packets are re-ordered in the correct order before data is forwarded to the end user.

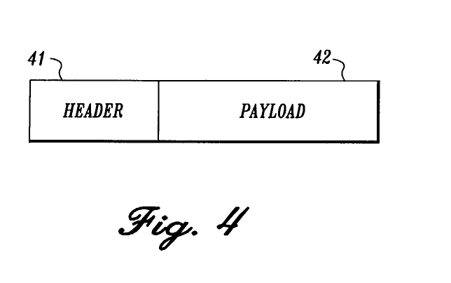

FIG. 3 further illustrates the LEO satellite communication network. End users 17a, 17b, 17c . . . are connected either through networks 19a and 19b . . . , or directly, to ground terminals 21a, 21b, 21c . . . The networks 19a, 9b, . . . may, for example, be conventional switched public telephone system networks, corporate networks or other proprietary networks.

Network operations and control systems 25a and 25b are shown as communicating with the satellites via separate terminals 23a and 23b. All of the ground terminals are designed to transmit signals to and receive signals from the constellation of satellites via uplink and downlink data channels. Since LEO satellites, in contrast to geosynchronous satellites, move with respect to the Earth, the region of the Earth covered by a satellite's footprint is also constantly moving. Preferably, the LEO satellite communication network of the present invention employs Earth-fixed cellular beam technology. In an Earth-fixed cellular beam system the surface of the Earth is mapped with a number of cells. As a LEO satellite passes over the Earth, the satellite's antennas are controlled so that the beams of the antennas are steered to remain pointed at the center of each cell located within a satellite's footprint. For a predetermined period of time, the cells located within the satellite's footprint are therefore served by the same satellite as the satellite moves in orbit over the cell. In contrast, conventional LEO satellites use a satellite-fixed beam approach in which the direction of the beams from the satellite are fixed with respect to the satellite, i.e., the beams are not steered. Although the present invention is applicable to a satellite-fixed beam as well as Earth-fixed cellular systems, an Earth-fixed cellular satellite communication system is preferred because it is believed to substantially reduce communication problems when compared to other systems.

Rather than each data message being continuously transmitted, as is well known in the cellular telephone communication and other arts, data transmissions are broken into digital data “packets.” As illustrated in FIG. 4, each packet includes a header 41 and a payload 42. While each is fixed in length, the number of databits in the header are substantially fewer than the number of databits in the payload. As will be better understood from the following description of data packets employed by the present invention, the header includes packet address bits, priority bits and other administrative and/or control bits. The address bits contain address and control information designed to direct the data packets to the intended destination of the related payload, which may be one or more of the satellites in the LEO satellite constellation, if the related payload is to be delivered to a satellite or a plurality of satellites, or a designated ground terminal, if the related payload is to be delivered to an end user. The payload, of course, contains the information being transmitted. If intended for a ground terminal, the ground terminal reassembles the packets of received data, if they are received out of order, in the appropriate sequential manner prior to forwarding the data packets to an end user.

The present invention is directed to a method and apparatus for transmitting data packets through a LEO satellite communication system of the type illustrated in FIGS. 1-3 in a way that enhances end user quality of service and overall transmission capacity while minimizing the complexity of the network design. This is accomplished by using standard data packets of uniform length and protocol on the uplink and downlink data communication channels while using asymmetric standard data packets on the intersatellite link data communication channels. As will be better understood from the following description, additional header databits are appended to standard data packets received by a LEO satellite via an uplink data communication channel. The appended additional header databits are designed to assist system management.

In a preferred embodiment, the appended additional header databits include timer count bits and a congestion bit. Timer count bits are useful in deciding if a data packet is lost (i.e., misrouted or unacceptably delayed) in the network and, thus, should be dropped. A congestion bit is useful for tracking the congestion status of a chosen routing path. Knowledge that a routing path is too congested allows system administration programs to establish a different routing path for future data packets destined for the same location. Thus, both timer count bits and a congestion bit are useful in enhancing end user quality of service.

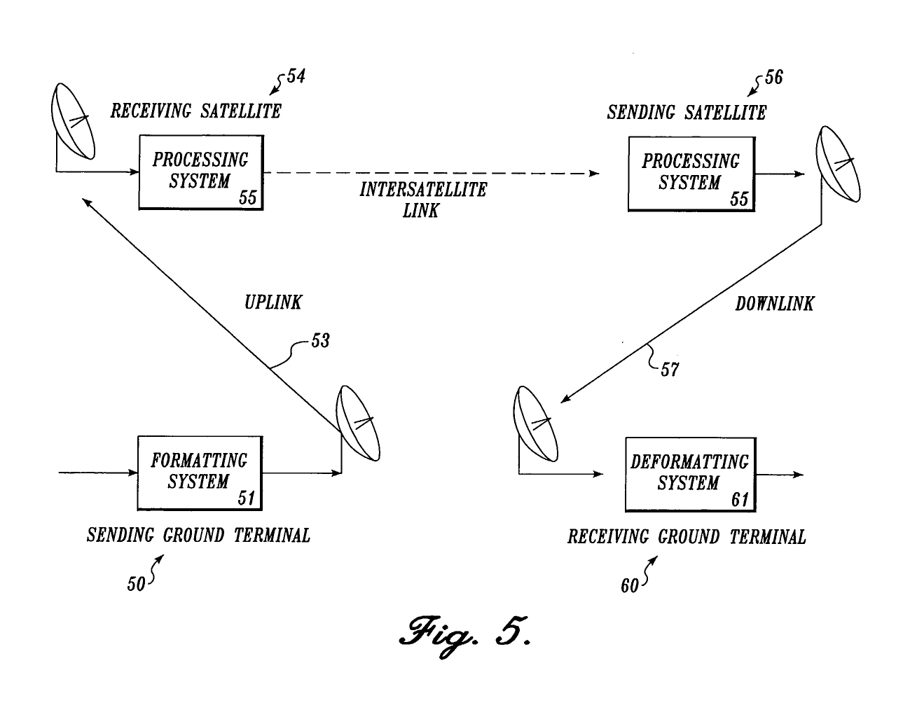

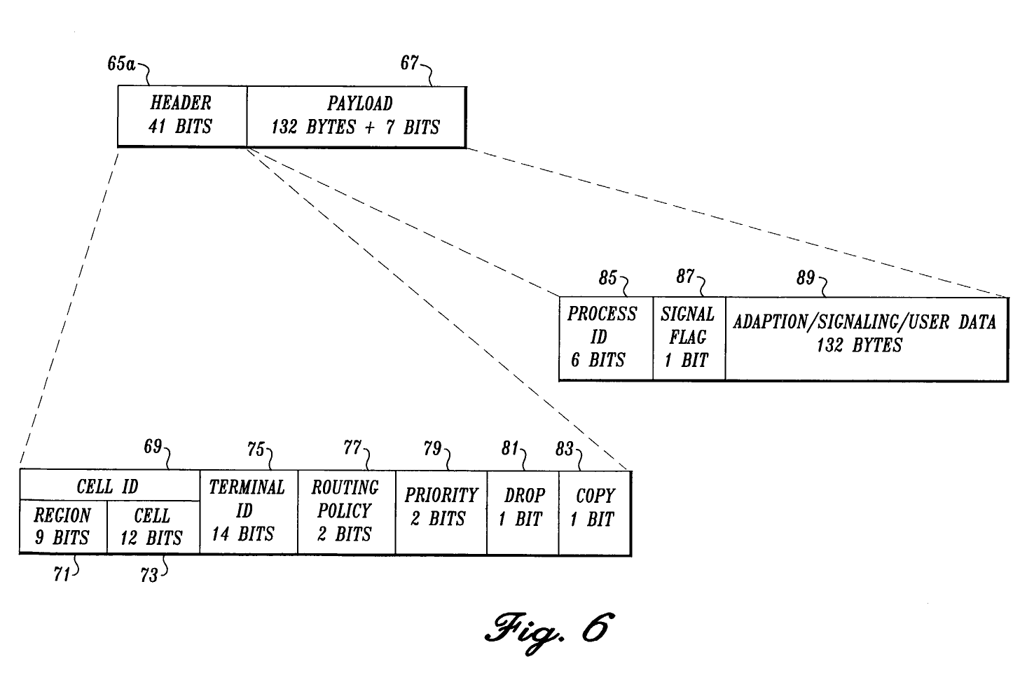

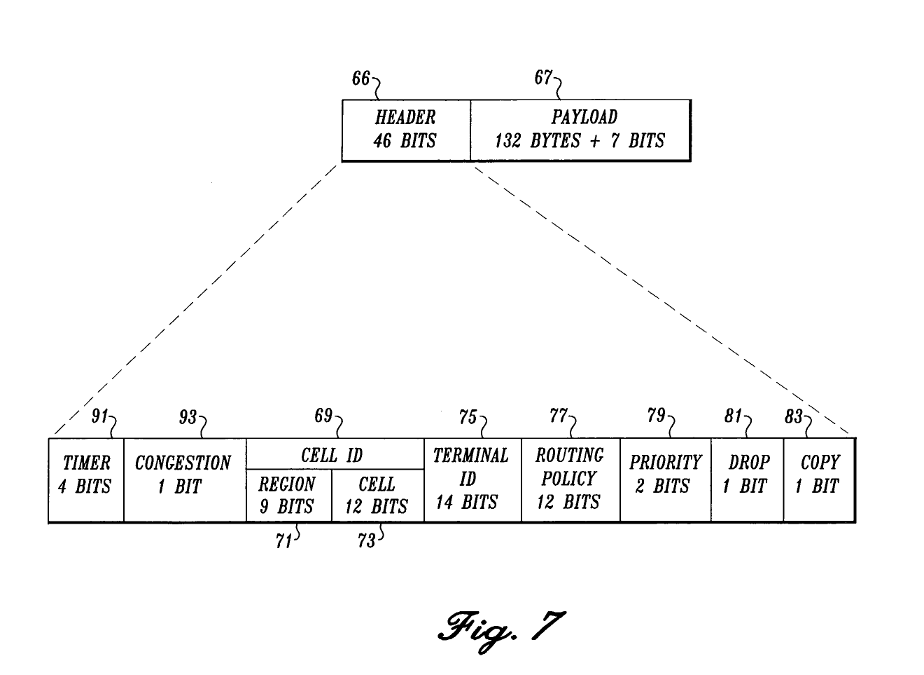

In accordance with the invention, data packets of varying lengths and protocols received from other networks or end users are first converted into standard data packets of uniform length. As shown in FIG. 5, this is accomplished by a formatting system 51 located in a sending ground terminal 50. FIG. 6 illustrates an example of a standard data packet. The exemplary standard data packet contains a standard header 65a composed of 41 databits and a standard payload 67 composed of 132 databytes plus 7 databits. As also shown in FIG. 6, the exemplary standard header includes cell ID bits 69, terminal ID bits 75, routing policy bits 77, priority bits 79, a drop bit 81 and a copy bit 83.

The cell ID bits 69 include region bits 71 and cell bits 73 if the related data packet is destined for a ground terminal. The region bits identify the geographic region in which the receiving ground terminal is located and the cell bits identify the cell within the region in which the terminal ground station is located. The terminal ID bits identify the receiving ground terminal. The routing policy bits define routing policy applicable to the data packet and the priority bits define the priority applicable to the data packet. The drop and copy bits are used for administrative functions. Obviously, the cell ID and terminal ID bits will not identify the location and identity of a ground terminal if the data packet is not destined for a ground terminal. If destined for a satellite, the cell ID and terminal ID bits would be replaced with satellite identity bits. The standard payload part of the data packet shown in FIG. 6 includes process ID bits 85, a signal flag bit 87, and adaptation, signaling or user databytes 89. The process ID identifies the adaptation, signaling or user databytes and the signal flag bit is used for administrative purposes.

All data packets that are transmitted via the uplink data channel have the same standard header and payload length and format. As shown in FIG. 5, the standard data packets are transmitted via an uplink data communication channel 53 to a receiving satellite 54 in the LEO satellite constellation serving the cell within which the sending ground terminal 50 lies.

An on-board processing system 55 located on the receiving satellite 54 appends to the standard header additional bits of information that are used to improve the transmission of the data packets through the LEO satellite network. As a result, the data packets routed through the LEO satellite network are asymmetric with respect to data packets received from the sending ground terminal 50.

FIG. 7 illustrates an exemplary asymmetric standard data packet. The header 66 of the asymmetric standard data packet shown in FIG. 7 includes timer count bits 91 and a congestion bit 93 appended to the databits of the standard header 65a illustrated in FIG. 6 and described above. As will be better understood from the following description, the on-board processing system 55 located on all LEO satellites tracks the length of time a data packet is in the LEO satellite system by decrementing the timer count bits 85. When the timer count bits indicate that the packet has been within the system beyond a predetermined maximum time, the on-board processing system drops the data packet based on the assumption that the data packet is lost (i.e., unacceptably delayed or misrouted) within the LEO satellite network. As also will be better understood from the following description, the on-board processing system 55 also tracks the congestion status of a chosen routing path and records this information in the congestion bit 87.

As noted above, the information contained in the header of a data packet is used to route the data packet through the LEO satellite constellation to either a satellite(s) destined to receive the data packet or to a sending satellite 56 serving the cell within which the receiving ground terminal associated with the end user destined to receive the data packet is located. En route, the data packets can pass through several satellites. Transmission from satellite to satellite is via intersatellite links, only one of which is shown in FIG. 5. At each satellite, the on-board processing system monitors and updates the timer count bits 85 and the congestion bit 87 as described in greater detail below.

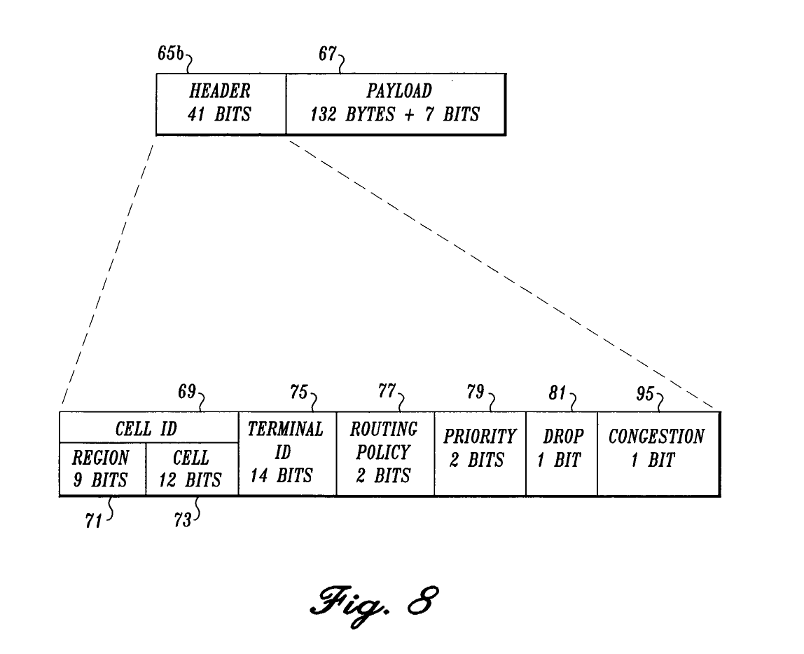

In the case of data packets destined for a ground terminal, once a data packet reaches the sending satellite 56, the sending satellite copies the congestion bit 87 to the copy bit 83 and removes the appended timer count databits 85 and the congestion bit 87, resulting in the creation of a modified standard data packet. FIG. 8 illustrates a modified standard data packet. The illustrated modified standard data packet has the same length as the original standard data packet—header 65b formed of 41 header databits followed by payload 67 formed of 132 payload databytes plus 7 payload databits. The only difference is that the copy bit 83 is now the copied congestion bit 95. As shown in FIG. 5, after eliminating the appended bits, the sending satellite 56 transmits the modified standard data packets to a receiving ground terminal 60 via a downlink data communication channel 57.

The receiving ground terminal 60 deformats received data packets into the original data packets of varying lengths and protocols. This is accomplished by a deformatting system 61 included in the receiving ground terminal 60. During the deformatting process, the receiving ground terminal 60 reads and stores the congestion bit information for use by administrative programs when setting the relevant databits of the header of later transmitted data packets. The receiving ground terminal 60 then reassembles the data packets in the appropriate order and forwards the reassembled data packets to the intended end user.

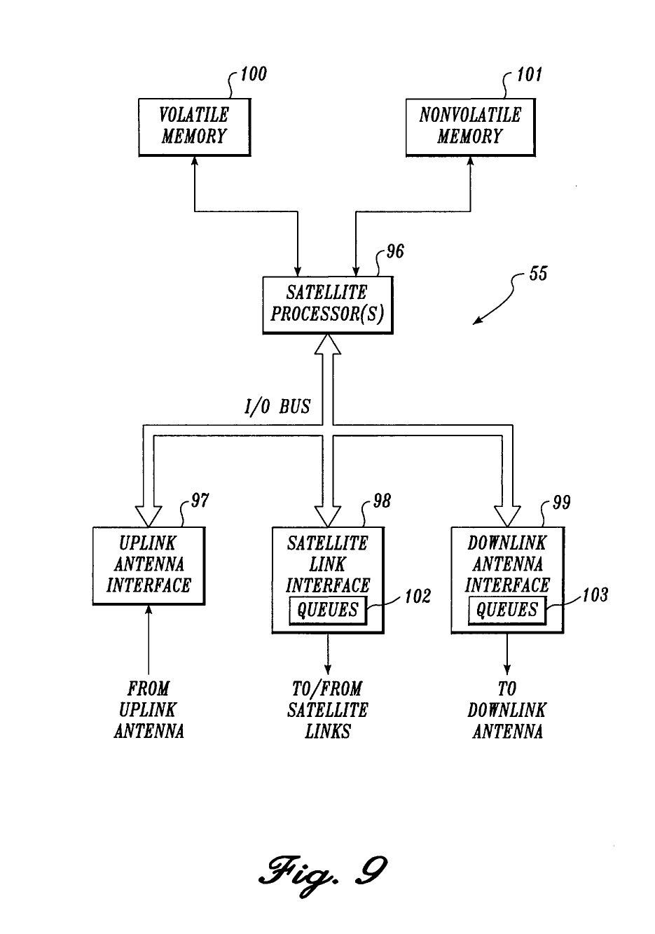

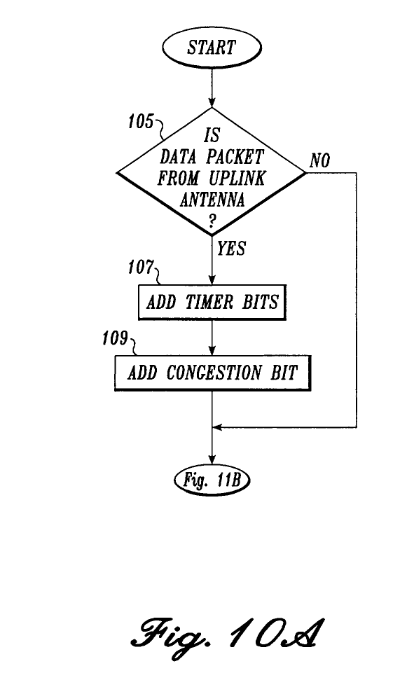

A functional block diagram of an exemplary processing system 55 suitable for use on-board the LEO satellites to append timer count bits and a congestion bit to the header of standard data packets and monitor and update (if necessary) the timer count bits and the congestion bit is shown in FIG. 9. The illustrated on-board processing system includes one or more processors 96 each of which contain or are connected to a volatile memory 100 and a nonvolatile memory 101. The processor(s) 96 sends and receives data to and from an uplink antenna interface 97, a satellite link interface 98, and a downlink antenna interface 99. Before data is transmitted via an intersatellite link or downlink data communication channel, the data is stored by the on-board processing system in intersatellite link queues 102 and downlink queues 103.

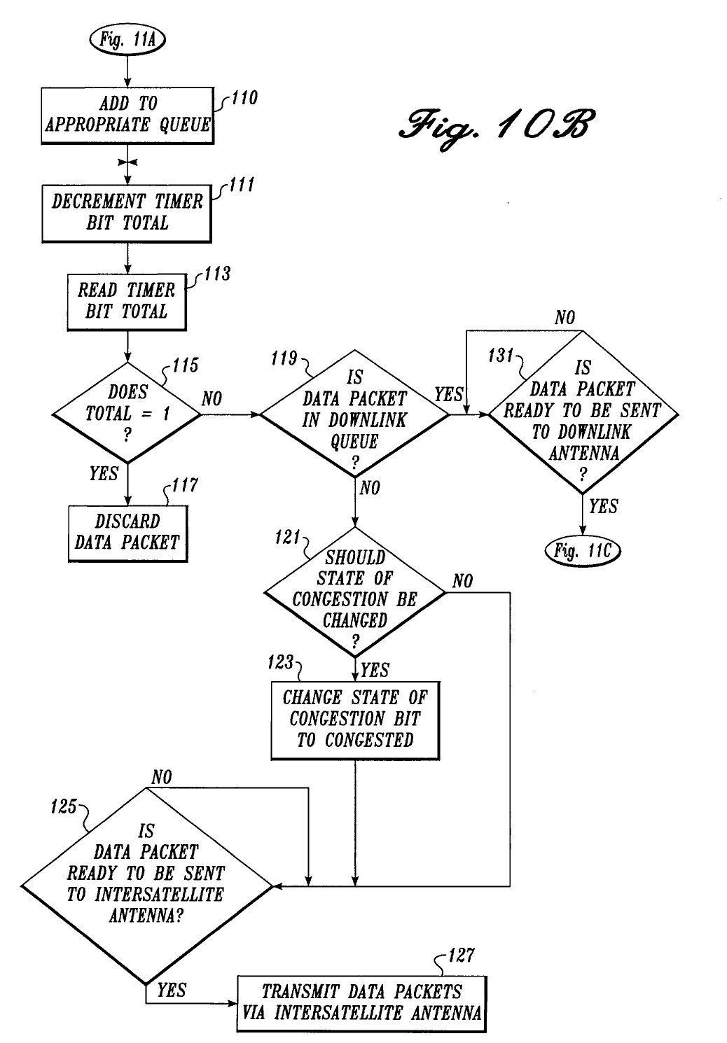

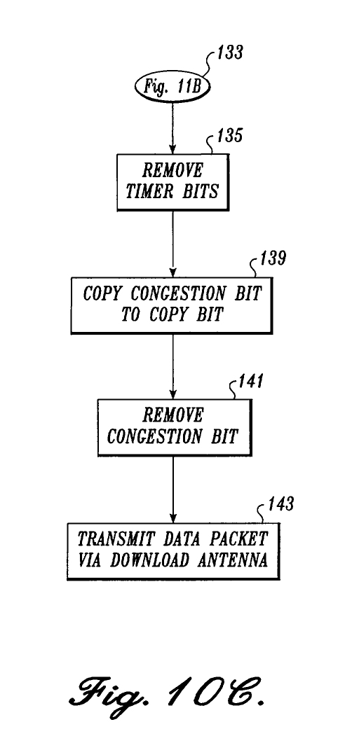

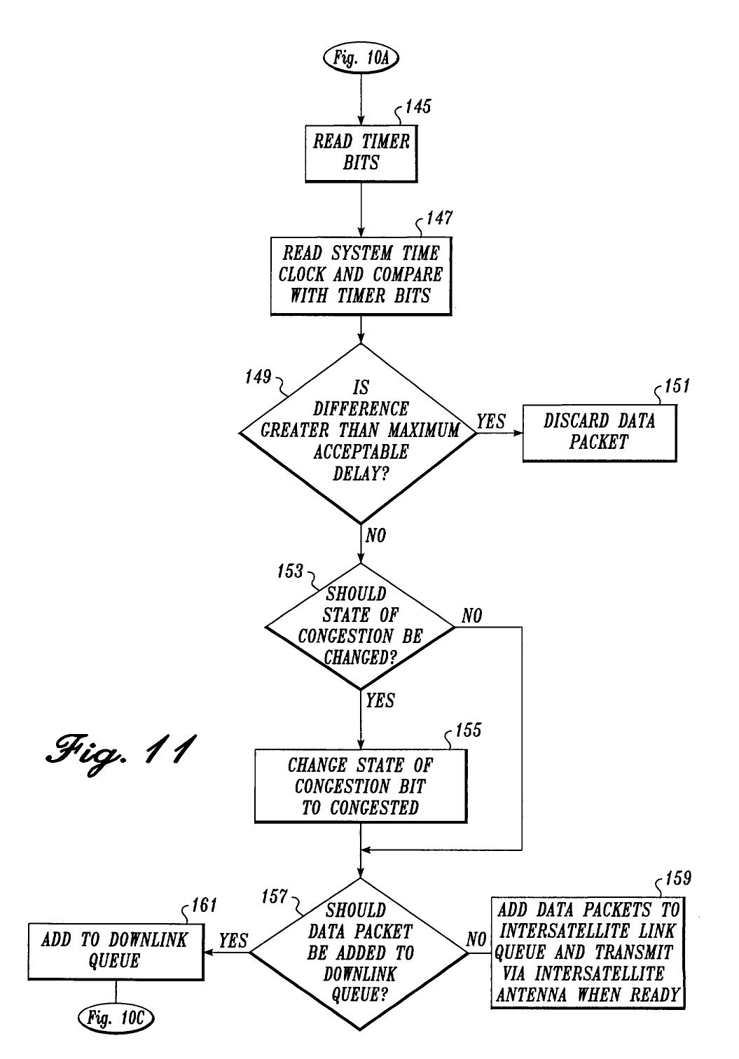

FIGS. 10A-10C are an exemplary functional block diagram illustrating how the on-board processing system 55, shown in FIG. 9, appends, updates, uses and removes the timer count bits 85 and the congestion bit 87. First, as shown in FIG. 10A, at block 105, a test is made to determine if a received data packet is from the uplink antenna interface 97. If the data packet is from the uplink antenna interface 97, the processing system appends the timer count bits 85 and the congestion bit 87 to the header of the standard data packet, producing an asymmetric standard data packet. See blocks 107 and 109. As will be described in additional detail below, the timer count bits are set to a predetermined value which may be used to track the amount of time that the asymmetric standard data packet is routed through the satellite constellation. After the asymmetric standard data packet is created, if the data packet is not from the uplink antenna interface 97, but rather the satellite link interface 98 and, thus, is already an asymmetric standard data packet, the asymmetric standard data packet is added to an appropriate queue 110 (FIG. 10B) based on where the data packet is to be routed (i.e., to another satellite or to a ground terminal serviced by the same satellite receiving the data packet).

In an actual embodiment of the invention, each satellite will likely have multiple queues, particularly downlink and intersatellite link queues. Furthermore, the actual embodiment will also likely have queues for each level of data packet priority, plus, potentially, queues for special types of data packets. Regardless of the number of queues, the timer count bits and the congestion bit of asymmetric standard data packets stored in the queues are updated in the manner functionally illustrated in FIG. 10B. As shown in block 111, once added to a queue, the timer count bits of an asymmetric standard data packet are decremented. Thereafter, the timer count bits are read at block 113 and a test is made at block 115 to determine if the timer count bits equal some predetermined value, such as one. If the timer count bits equal the predetermined value, the asymmetric data packet is discarded. See block 117. Discarding the packet means that the packet is removed from the queue and no longer routed through the communication system. If the timer count bits do not equal the predetermined value, the on-board processing system then determines if the asymmetric standard data packet is in a downlink queue. See block 119.

If the asymmetric standard data packet is not in a downlink queue, but rather is in an intersatellite link queue, a test is made to determine if the state of the congestion bit should be changed to a congested state at a block 121. The basis of the test could be the number of data packets in the intersatellite link queue or the average time it takes for packets to pass through the queue, for example. If the initial congestion bit were a binary zero, indicating a low congestion state at block 123, the congestion bit would be changed to a binary one if the test indicates that the queue is congested. If already in the congested state due to congestion in another queue, the congestion bit remains in the congested state.

As shown in FIG. 10B, if the congestion bit state is not to be changed or after the congestion bit has been changed to the congested state, the on-board processor determines if the asymmetric standard data packet is ready to be sent to an intersatellite antenna for transmission. See block 125. As shown in block 127, if ready for transmission, which is indicated by reaching the end of its queue, the asymmetric standard data packet is transmitted via an intersatellite antenna. Otherwise, the asymmetric standard data packet remains in its position in the queue until the end of the queue is reached and the data packet is ready for transmission.

Turning to the asymmetric data packets in a downlink queue, at a block 131 a test is made to determine if a data packet has reached the end of the downlink queue. If the data packet is at the end of the queue and is to be forwarded to the downlink antenna, at a block 135 (FIG. 10C) the processing system removes the timer count bits from the header of the data packet. At block 139, the congestion bit is copied to the copy bit 83. At block 141, the congestion bit is removed from the header of the data packet, creating a modified standard data packet that is still of uniform length. Finally, the modified standard data packet is transmitted via the downlink antenna. See block 143.

Returning to blocks 110 and 111, as a packet is added to a queue, the timer count bits are preferably decremented only once. If only decremented when a packet is added to the queue, the timer count bits act as a “hop” count to keep track of the number of satellites traversed by the packet as it is routed through the satellite constellation. When the maximum number of allowable hops is reached by the packet (as determined by the timer count bits equaling a preset number, e.g., when the timer count bits=0001), the packet is dropped. When the timer count bits are used as a hop count, the maximum number of allowable hops is determined by the difference between the initial value of the timer count bits and the preset number after which the packet is dropped. It will be appreciated that the number of allowable hops may be varied to reflect the quality of service of the associated packets. For example, those packets having a delivery that is not time sensitive may have the timer count bits set to allow a greater number of allowable hops before being dropped.

Alternatively, rather than acting as a hop count, the timer count bits may be used in conjunction with a system time clock to maintain track of the actual time a packet remains within the system. FIG. 11 is a modified functional flow diagram of FIG. 10B illustrating this alternative embodiment. A common system time clock having the same number of bits as the timer control bits is maintained throughout the LEO satellite constellation. When the timer count bits are added to the standard data packet at block 107 (FIG. 10A), the timer count bits are set to the value of the time represented by the system time clock. Then, as shown in FIG. 11, before being added to a satellite queue, the timer count bits are read and compared with the bits of the system time clock. See blocks 145 and 147. At block 149, if the difference between the timer count bits and the system time clock bits is equal to or greater than a maximum acceptable delay time, the data packets are discarded. See block 151. It will be appreciated that in the alternative embodiment, the period of time associated with each bit of the system time clock is used to calculate the elapsed time that a packet remains in the system. For example, if each bit in the system time clock equals 10 milliseconds, a system time clock of “0011” and a timer count bits setting of “1001” indicates that the packet has been in the system for approximately 60 milliseconds. Those skilled in the art will recognize that the resolution of the system time clock may be varied depending on the required accuracy in the system and that provision must be made for the system time clock “rolling-over.”

Returning to decision block 149, if the difference is less than the maximum acceptable delay time, a test is made to determine if the congestion status should be changed at block 153. Again, the satellite processor may base this test on the number of packets in the queue or the average time it takes data packets to pass through the queue. If necessary, the congestion status is changed at block 155. Thereafter, the system determines whether the asymmetric standard data packet should be added to a downlink or intersatellite link queue and adds it to the appropriate queue. See blocks 157, 159, and 161. If added to an intersatellite link queue, the asymmetric standard data packet is transmitted via an intersatellite antenna when ready. Alternatively, if added to a downlink queue, the asymmetric standard data packet is thereafter acted upon as shown in FIG. 10C and as described above.

As will be readily appreciated by those skilled in the art and others, a LEO satellite data communication system formed in accordance with the invention has a number of advantages. Because of the changing topography of a LEO satellite communication network, such a network is best suited to transmitting fixed length data packets. Creating fixed length data packets in the ground terminals require less satellite power and complexity than does the creation of variable length data packets.

Furthermore, because data transmission between the Earth and the satellites occurs over a bandwidth that is fixed by regulatory agencies, the total amount of data that may be transmitted between the ground terminals and the LEO satellites is fixed. In contrast, the intersatellite links that interconnect the satellites are not constrained by a fixed bandwidth and therefore may be sized to have a greater capacity than will likely be used at any given time. Thus, while it is important to minimize the amount of data transmitted between the ground and the satellites, it is not as important to minimize the amount of data transmitted between the satellites in the LEO network. Creating fixed length data packets on the ground and appending header databits on the satellites allows the system to take advantage of the additional bandwidth available between the satellites. As a result, the overall data transmission capacity of the network is maximized.

Moreover, end user quality of service is also improved by adding timer count bits and a congestion bit to the headers of standard data packets at the receiving satellite. The timer count bits are used to prevent lost data packets from congesting the LEO satellite communication system, thus providing better flow and routing control. The congestion bit is used to determine whether the predetermined routing paths are heavily congested at any point. The congestion information can be used by administration programs to route data packets away from areas of congestion, thus improving the quality of service and equally distributing traffic throughout the system.

While the preferred embodiment of the invention has been illustrated and described, it will be appreciated that various changes can be made therein without departing from the spirit and scope of the invention. For example, the number of header and payload databits can vary with respect to one another within the fixed length data packet as well as with respect to the total length of the fixed length data packet. Furthermore, the header and payload databits can contain information other than that shown in FIGS. 7, 8 and 9 and described above.

It will be appreciated that the appended asymmetric header databits can vary depending upon system management requirements. Additional databits other than timer count bits and a congestion bit could be added to the data packet to support other system functions, such as routing. The use of the timer count bits and congestion bit may also be different from that described above. For example, the satellite processing system can increment the timer count bits until the bits reach a predetermined limit, rather than decrementing the timer count bits until the bits reach one or some other predetermined value. If system management requires that the congestion status of the satellite routes be monitored, the processing system may append more than one congestion databit for assistance in determining the precise location of the congestion, rather than include a single bit that can only be used to indicate whether the route in general was congested.

Further, the invention can be used with other types of satellite communication systems. Hence, within the scope of the appended claims, it is to be understood that the invention can be practiced otherwise than as specifically described herein.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A data communication system for a communication network comprising a constellation of low-Earth-orbit (LEO) satellites and ground terminals for sending data packets to and receiving data packets from the low-Earth-orbit satellites forming said constellation, said data packets including header databits and payload databits, said header databits including information regarding the destination of the payload databits, said data communication system comprising:
a formatting system located in said ground terminals for: (i) receiving data packets of varying lengths from other networks or end users; (ii) formatting said data packets into standard data packets of a uniform length; and (iii) transmitting said standard data packets to one of said low-Earth-orbit satellites;
a processing system in said low-Earth-orbit satellites for: (i) receiving said standard data packets from one of said ground terminals; (ii) appending system management data to the headers of said standard data packets to create asymmetric standard data packets; (iii) transmitting said asymmetric standard data packets to other low-Earth-orbit satellites; (iv) receiving said asymmetric standard data packets from said other low-Earth-orbit satellites; (v) removing the appended system management data from the headers of said asymmetric data packets that are destined for one of said ground terminals to create reproduced standard data packets; and (vi) transmitting said reproduced standard data packets to said one of said ground terminals; and
a deformatting system in said ground terminals for: (i) receiving said reproduced standard data packets; (ii) deformatting said reproduced standard data packets to create the original data packets of varying lengths; and (iii) transmitting said original data packets to destined other networks or end users.

2. A data communication system as claimed in claim 1, wherein said system management data includes a timer count for tracking the length of time a data packet is in the LEO satellite system and dropping the data packet after a predetermined time has elapsed.

3. A data communication system as claimed in claim 1, wherein said system management data includes a timer count for tracking the number of hops a data packet makes within the LEO satellite system and dropping the data packet after a predetermined number of hops is exceeded.

4. A data communication system as claimed in claim 1, wherein said system management data includes a congestion indicator for recording the congestion status of a routing path.

5. A data communication system for a communication network comprising a constellation of low-Earth-orbit (LEO) satellites and ground terminals for sending data packets to and receiving data packets from the low-Earth-orbit satellites forming said constellation, said data packets including header databits and payload databits, said header databits including information regarding the destination of the payload databits, said data communication system comprising:
a formatting system located in said ground terminals for: (i) receiving data packets of varying lengths from other networks or end users; (ii) formatting said data packets into standard data packets of a uniform length; and (iii) transmitting said standard data packets to one of said low-Earth-orbit satellites;
a processing system in said low-Earth-orbit satellites for: (i) receiving said standard data packets from one of said ground terminals; (ii) appending data including a timer count and a congestion indicator to the headers of said standard data packets if received directly from one of said ground terminals to create asymmetric standard data packets; (iii) receiving asymmetric standard data packets already containing said timer count and said congestion indicator from other of said low-Earth-orbit satellites; (iv) decrementing said timer count; (v) reading said timer count; (vi) discarding said asymmetric standard data packets if said timer count has reached a predetermined magnitude; (vii) updating said congestion indicator to reflect the status of congestion in said low-Earth-orbit satellites; (viii) forwarding said asymmetric standard data packets to another of said low-Earth-orbit satellites if said asymmetric standard data packets' next destination is not one of said ground terminals; (ix) removing said timer count if said asymmetric standard data packets' next destination is one of said ground terminals; (x) reading and copying data from said congestion indicator over a copy bit if said asymmetric standard data packets' next destination is one of said ground terminals; (xi) removing said congestion indicator if said asymmetric standard data packets' next destination is one of said ground terminals to produce modified standard data packets of said uniform length; and (xii) forwarding said modified standard data packets to one of said ground terminals; and
a deformatting system in said ground terminals for: (i) receiving said modified standard data packets; (ii) deformatting said modified standard data packets to reproduce the original data packets of varying lengths; and (iii) transmitting said original data packets to destined other networks or end users.

6. A data communication system as claimed in claim 5, wherein said processing system located in said low-Earth-orbit satellites includes:
a processor or a number of processors for: (i) receiving said standard data packets from one of said ground terminals; (ii) appending data including a timer count and a congestion indicator to the headers of said standard data packets if received directly from one of said ground terminals to create asymmetric standard data packets; (iii) receiving asymmetric standard data packets already containing said timer count and said congestion indicator from other of said low-Earth-orbit satellites; (iv) decrementing said timer count; (v) reading said timer count; (vi) discarding said asymmetric standard data packets if said timer count has reached a predetermined magnitude; (vii) updating said congestion indicator to reflect the status of congestion in said low-Earth-orbit satellites; (viii) forwarding said asymmetric standard data packets to an intersatellite link interface if said asymmetric standard data packets' next destination is not one of said ground terminals; (ix) removing said timer count if said asymmetric standard data packets' next destination is one of said ground terminals; (x) reading and copying data from said congestion indicator over a copy bit if said asymmetric standard data packets' next destination is one of said ground terminals; (xi) removing said congestion indicator if said asymmetric standard data packets' next destination is one of said ground terminals to produce modified standard data packets of said uniform length; and (xii) forwarding said modified standard data packets to a downlink antenna interface if said asymmetric standard data packets' next destination is one of said ground terminals;
a downlink antenna interface for forwarding the modified standard data packets to one of said ground terminals; and
an intersatellite link interface for forwarding the asymmetric standard data packets to another of said low-Earth-orbit satellites.

7. A data communication method for a communication network comprising a constellation of low-Earth-orbit (LEO) satellites and ground terminals for sending data packets to and receiving data packets from the low-Earth-orbit satellites forming said constellation, said data packets including header databits and payload databits, said header databits including information regarding the destination of the payload databits, said method comprising:
formatting data packets of varying lengths received from other networks or end users into standard data packets of a uniform length to be transmitted by said ground terminals;
transmitting said standard data packets to one of said LEO satellites;
receiving said standard data packets at one of said LEO satellites;
processing said standard data packets at one of said low-Earth-orbit satellites by appending system management data to the headers of said standard data packets to create asymmetric standard data packets;
conveying said asymmetric standard data packets through said constellation of LEO satellites to another of said LEO satellites;
deprocessing said asymmetric standard data packets at said other satellite by removing the appended system management data from the headers of said asymmetric data packets which are destined for one of said ground terminals to create reproduced standard data packets;
transmitting said reproduced standard data packets to one of said ground terminals;
receiving said reproduced standard data packets at one of said ground terminals;
deformatting said reproduced standard data packets to create the original data packets of varying lengths at said ground terminals to be later transmitted to destined other networks or end users.

8. A data communication method for a communication network comprising a constellation of low-Earth-orbit (LEO) satellites and ground terminals for sending data packets to and receiving data packets from the low-Earth-orbit satellites forming said constellation, said data packets including header databits and payload databits, said header databits including information regarding the destination of the payload databits, said method comprising:
formatting data packets of varying lengths received from other networks or end users into standard data packets of a uniform length to be transmitted by said ground terminals;
transmitting said standard data packets to one of said LEO satellites;
receiving said standard data packets at one of said LEO satellites;
processing said standard data packets at the receiving one of said low-Earth-orbit satellites by appending data including a timer count and a congestion indicator to the headers of said standard data packets to produce asymmetric standard data packets;
conveying said asymmetric standard data packets through said constellation of LEO satellites to another of said LEO satellites;
processing said asymmetric standard data packets at said other satellite by: (i) decrementing said timer count; (ii) reading said timer count; (iii) discarding said asymmetric standard data packets if said timer count has reached a predetermined value; (iv) updating said congestion indicator to reflect the status of congestion in said low-Earth-orbit satellites; (v) removing said timer count if said asymmetric standard data packets' next destination is one of said ground terminals; (vi) reading and copying data from said congestion indicator over a copy bit if said asymmetric standard data packets' next destination is one of said ground terminals; and (vii) removing said congestion indicator if said asymmetric standard data packets' next destination is one of said ground terminals to produce modified standard data packets of said uniform length;
transmitting said modified standard data packets to one of said ground terminals;
receiving said modified standard data packets at one of said ground terminals; and
deformatting said modified standard data packets to create the original data packets of varying lengths at said ground terminals to be later transmitted to destined said networks or end users.

9. In a data communication system comprising a constellation of satellites and ground terminals for sending data packets to and receiving data packets from the satellites forming said constellation, said data packets including header databits and payload databits, said header databits including information regarding the destination of the payload databits, the improvement comprising a processing system in said satellites for: (i) receiving said data packets from one of said ground terminals; (ii) appending system management data to said data packets to create modified data packets; (iii) transmitting said modified data packets to other satellites; (iv) receiving said modified data packets from said other satellites; (v) removing the appended system management data from said modified data packets that are destined for one of said ground terminals to create reproduced data packets; and (vi) transmitting said reproduced data packets to said one of said ground terminals.

10. The improvement as claimed in claim 9, wherein said system management data includes a timer count for tracking the length of time a data packet is in the constellation of satellites and dropping the data packet after a predetermined time has elapsed.

11. The improvement as claimed in claim 9, wherein said system management data includes a timer count for tracking the number of satellites a data packet traverses within the constellation of satellites and dropping the data packet after a predetermined number of satellites is traversed.

12. The improvement as claimed in claim 9, wherein said system management data includes a congestion indicator for recording the congestion status of a chosen routing path.

13. In a data communication system comprising a constellation of satellites and ground terminals for sending data packets to and receiving data packets from the satellites forming said constellation, said data packets including header databits and payload databits, said header databits including information regarding the destination of the payload databits, the improvement comprising a processing system in said satellites for: (i) receiving said data packets from one of said ground terminals; (ii) appending data including a timer count and a congestion indicator to the headers of said data packets if received directly from one of said ground terminals to create modified data packets; (iii) receiving modified data packets already containing said timer count and said congestion indicator from other of said satellites; (iv) decrementing said timer count; (v) reading said timer count; (vi) discarding said modified data packets if said timer count has reached a predetermined magnitude; (vii) updating said congestion indicator to reflect the status of congestion in said satellites; (viii) forwarding said modified data packets to another of said satellites if said modified data packets' next destination is not one of said ground terminals; (ix) removing said timer count if said modified data packets' next destination is one of said ground terminals; (x) reading and copying data from said congestion indicator over a copy bit if said modified data packets' next destination is one of said ground terminals; (xi) removing said congestion indicator if said asymmetric standard data packets' next destination is one of said ground terminals to reproduce data packets; and (xii) forwarding said reproduced data packets to one of said ground terminals.
